(19) United States
(12) Patent Application Publication
(10) Pub. No.: US 2015/0348705 A1
(43) Pub. Date: Dec. 3, 2015

(54) MOLD FOR MANUFACTURING SINTERED MAGNET AND METHOD OF MANUFACTURING SINTERED MAGNET

(71) Applicant: DAIDO STEEL CO., LTD., Nagoya (JP)

(72) Inventor: Shinobu TAKAGI, Aichi (JP)

(73) Assignee: DAIDO STEEL CO., LTD., Nagoya (JP)

(21) Appl. No.: 14/709,714

(22) Filed: May 12, 2015

(30) Foreign Application Priority Data
May 28, 2014 (JP) 2014-110352

(51) Int. Cl. H01F 41/02; H01F 1/057; B22F 5/00; H01F 1/053; B22F 3/00; B22F 3/12

(52) U.S. Cl. CPC H01F 41/0266; B22F 3/003; B22F 3/12; B22F 5/00; H01F 1/0536; H01F 1/0577

(57) ABSTRACT

The present invention relates to a mold for manufacturing a sintered magnet, the mold containing: a main body having an opening; and a lid that covers the opening and has an inner surface which is located on a main body side in a state of covering the opening, in which the inner surface has a plane surface which intersects with an inner wall surface of the main body at an obtuse angle, or has a curved surface where a tangent plane of each point on an intersection line with the inner wall surface intersects with the inner wall surface at an obtuse angle.

### TECHNICAL FIELD

The present invention relates to a mold for manufacturing a sintered magnet and a method of manufacturing a sintered magnet by using the mold.

### BACKGROUND ART

When a sintered magnet is manufactured, there has been employed such a method including: filling a mold with powder (hereinafter, referred to as “alloy powder”) obtained by pulverizing an alloy ingot of raw materials (filling process); orienting particles of the alloy powder by applying a magnetic field to the alloy powder in the mold (orienting process); applying a pressure to the oriented alloy powder to obtain a compression molded article (compression molding process); and sintering the compression molded article by heating the compression molded article after being released from the mold (sintering process). Alternatively, a method of simultaneously performing the orienting process and the compression molding process by applying a pressure to the alloy powder by using a press machine while applying a magnetic field thereto after the filling process may also be adopted. Since compression molding is performed by using a press machine in all these methods, these methods will be referred to as “press method” in this specification.

On the other hand, recently, it has been found that a sintered magnet having a shape corresponding to a cavity of a mold can be manufactured by filling the mold with an alloy powder and then orienting and sintering the alloy powder in a state of being put into the mold without compression-molding the alloy powder (Patent Document 1). In this specification, such a method of manufacturing a sintered magnet without performing the compression molding process will be referred to as “PLP (Press-less Process)”. In the PLP, when the mold is filled with the alloy powder, the alloy powder may be put into the mold at a pressure (approximately 2 MPa or less) which is sufficiently lower than a pressure (typically, several tens of MPa) applied during compression molding.

The PLP is particularly suitable for manufacturing an RFeB sintered magnet due to the following reasons. The RFeB sintered magnet is a sintered magnet containing a rare earth element R (one element or two or more elements selected from Sc, Y, La, Ce, Pr, Nd, Pm, Sm, Eu, Gd, Tb, Dy, Ho, Er, Tm, Yb, and Lu), Fe, and B as major components, and has an advantageous effect in that most magnetic properties such as residual magnetic flux density are higher than those of conventional permanent magnets but has a problem in that the coercive force is low. The coercive force is a measure of an ability to maintain magnetization when an external magnetic field is applied in a direction different from its magnetization direction. In general, the higher the temperature, the lower the coercive force. Therefore, in order for the RFeB sintered magnet to be used in an automotive motor or the like which is used at a relatively high temperature around 200° C. and has large variations in magnetic field direction, it is necessary that the coercive force be sufficiently high. In a NdFeB sintered magnet mainly containing Nd as the rare earth element R, the coercive force can be improved by adding Tb and/or Dy thereto, but there are problems in that the residual magnetic flux density and the maximum energy product decrease, and the use of Tb or Dy which is more expensive and rarer than Nd is required. On the other hand, according to the PLP, not only the coercive force but also the residual magnetic flux density and the maximum energy product can be improved due to the following reasons. Therefore, the amount of Tb or Dy used can be made to be small or zero.

In the PLP, it is not necessary to use a press machine. Therefore, the size of facilities can be reduced as compared to the press method, and it is easy to install the entirety of the facilities in an oxygen-free atmosphere. Accordingly, as compared to the press method, particles of an alloy powder are not likely to be oxidized during the manufacture of a sintered magnet, and thus the average particle size thereof can be reduced (the total surface area of the particles of the alloy powder can increase). By reducing the average particle size of the alloy powder, the average particle size of fine crystals in the manufactured sintered magnet can also be reduced. As a result, when an external magnetic field is applied in a direction different from a magnetization direction, a magnetic domain with reversed magnetization is not likely to be formed, and thus the coercive force is improved. In addition, by applying no pressure to the alloy powder during and after the orienting process, disorder of orientation can be prevented. Therefore, the residual magnetic flux density and the maximum energy product can be improved.

Since an extremely high pulsed magnetic field is applied to the alloy powder in the orienting process, the alloy powder in the mold significantly moves and, if an opening is formed in the mold, is scattered outside the mold through the opening. In general, in the PLP, in order to prevent the alloy powder in the mold from being scattered outside the mold, the orienting and sintering processes are performed after supplying the alloy powder to a main body of the mold having an opening and then inserting a lid into the opening to be fitted thereto. Here, the lid being fitted to the opening of the mold main body represents that the volume of a space (referred to as “cavity”) formed between the main body and the lid is reduced by closing the opening with the lid and moving the lid along the opening. That is, the operation of fitting the lid to the opening of the main body has an effect of improving the filling density of the alloy powder in addition to an effect of sealing the cavity so as to prevent the powder from being scattered.

Alternatively, in the PLP, the opening of the main body may be covered with a plate-shaped lid without being fitted therewith. In this case, the powder in the main body is prevented from being scattered outside the mold by fixing the lid to the main body through a screw or the like or by pressing the lid against the mold by using a piston or the like (refer to Patent Document 2).

Patent Document 1: WO 2006/004014

Patent Document 2: WO 2010/134578

### SUMMARY OF THE INVENTION

In a conventional mold, for example, as illustrated in FIG. 14, an inner surface 923 (surface on a cavity side) of a lid 92 is a flat plane surface, and when an opening of a main body 91 of the mold is covered with the lid 92, the inner surface 923 of the lid 92 is perpendicular to inner wall surfaces 913 of the main body 91. That is, at edge lines 93 crossing between the inner wall surfaces 913 of the main body 91 and the inner surface 923 (surface on the cavity side) of the lid 92, the inner wall surfaces 913 of the main body 91 and the inner surface 923 of the lid 92 are perpendicular to each other. A sintered body manufactured by using such the mold through the PLP has sharp corners (so-called “sharp edges”; this portion is hereinafter referred to as “edges”), that is, having a right angle, at a portions corresponding to the edge line portions. At the edges of the sintered magnet, chipping or cracking is likely to occur in itself during transport or use, and destruction of the main body may be initiated from such a crack. In addition, a functional film may be formed on the surface of the sintered magnet in some cases for the purpose of, for example, improving corrosion resistance, but the peeling of this functional film may be initiated from the edges. Therefore, when the sintered body obtained in the sintering process is finished into a final product, the edges are chamfered by mechanical grinding or mechanical polishing. However, there are problems in that such the mechanical grinding process or mechanical polishing process increases the number of the manufacturing processes of the sintered magnet, the cost increases, and an amount of the material removed by the polishing is wasted. In addition, barrel polishing which is a type of mechanical polishing requires less time and effort as compared to other methods, but portions other than the edges are also polished. Therefore, the material is further wasted, and the shape of the sintered magnet may not be maintained as designed.

An object to be achieved by the present invention is to provide a mold for manufacturing a sintered magnet and a method of manufacturing a sintered magnet, in which a sintered magnet can be manufactured without performing mechanical grinding and mechanical polishing for chamfering.

According to a first aspect of the present invention for achieving the above-described object, there is provided a mold for manufacturing a sintered magnet by filling the mold with an alloy powder of raw materials of a sintered magnet and then orienting and sintering the alloy powder in a state of being put into the mold without compression-molding the alloy powder, the mold including:

a) a main body having an opening; and

b) a lid that covers the opening and has an inner surface which is located on the main body side in a state of covering the opening,

in which the inner surface has a plane surface which intersects with an inner wall surface of the main body at an obtuse angle, or has a curved surface where a tangent plane of each point on an intersection line with the inner wall surface intersects with the inner wall surface at an obtuse angle.

In the mold for manufacturing a sintered magnet according to the first aspect, the alloy powder is supplied to the internal space from the opening of the main body, and then the opening is covered with the lid. This lid prevents the alloy powder from being scattered in the orienting process. In addition, the filling density of the alloy powder can be adjusted to be a value appropriate for the PLP.

When the opening is covered with the lid as described above, in the mold for manufacturing a sintered magnet according to the first aspect, the inner surface of the lid intersects with the inner wall surface of the main body on the intersection line at an obtuse angle. That is, in the vicinity of a contact portion with the inner wall surface of the main body, the inner surface of the lid intersects with the inner wall surface of the main body at an obtuse angle. Therefore, in a sintered magnet obtained by using this mold through the PLP, an edge corresponding to the intersection line has an obtuse angle. Therefore, in a sintered magnet manufactured by using the mold for manufacturing a sintered magnet according to the first aspect, it is not necessary to chamfer at least the edge, and thus mechanical grinding and mechanical polishing are not necessary.

The lid may be fitted to the opening of the main body or may be fixed to the main body without being fitted to the opening. In the latter case, the lid has a concave portion on the inner surface, and the wall surface of the concave portion has a plane surface which intersects with the inner wall surface of the main body on the intersection line at an obtuse angle, or has a curved surface where a tangent plane of each point on the intersection line intersects with the inner wall surface of the main body at an obtuse angle.

According to a second aspect of the present invention, there is provided a mold for manufacturing a sintered magnet by filling the mold with an alloy powder of raw materials of a sintered magnet and then orienting and sintering the alloy powder in a state of being put into the mold without compression-molding the alloy powder, the mold including:

a) a main body having an opening; and

b) a lid that covers the opening and has an inner surface having a concave portion which is located on the main body side in a state of covering the opening,

in which the inner surface has a concave inner wall surface and a concave top surface,

the concave inner wall surface is connected to the inner wall surface of the main body through one plane surface or curved surface, and

the concave top surface has a plane surface which intersects with the concave inner wall surface at an obtuse angle, or has a curved surface where a tangent plane of each point on an intersection line with the concave inner wall surface intersects with the concave inner wall surface at an obtuse angle.

In the mold for manufacturing a sintered magnet according to the second aspect, a sintered magnet is obtained in which a surface having one continuing plane surface or curved surface is formed at the portion corresponding to the opening of the main body and an obtuse angle is formed at the portion where the concave inner wall surface and the concave top surface intersect with each other. Therefore, in a sintered magnet manufactured by using the mold for manufacturing a sintered magnet according to the second aspect, it is not necessary to chamfer at least the above-described portion, and thus mechanical grinding and mechanical polishing are not necessary.

The mold for manufacturing a sintered magnet according to the present invention may have a configuration in which plural openings (and internal spaces constituting the cavities) are one-dimensionally or two-dimensionally provided in parallel in an integrated type main body, and plural lids corresponding to the respective openings are integrally formed on a single plate. As a result, a troublesome operation of covering each opening with each lid is not necessary, and plural openings can be accurately covered with the lids at a stroke. Therefore, the manufacturing efficiency can be improved.

The mold for manufacturing a sintered magnet according to the first aspect may have a configuration in which a convex portion corresponding to the lid is formed on a bottom surface (a surface opposite the opening) of the main body integrally with the main body. In the mold for manufacturing a sintered magnet, plural main bodies having the same shape can be used by overlapping with each other. This configuration can be suitably applied to, in particular, a mold for manufacturing a sintered magnet having the above-described configuration in which plural openings are one-dimensionally or two-dimensionally provided in parallel in an integrated type main body. In this case, the above-described single plate for forming plural lids is not necessary. Therefore, as compared to a case where plural main bodies separately covered with individual lids overlap each other, the number of steps at the same height can be increased, and thus the manufacturing efficiency of a sintered magnet can be improved.

According to the present invention, there is provided a method of manufacturing a sintered magnet including:

a filling process of supplying the alloy powder to an internal space of the main body of any one of the molds for manufacturing a sintered magnet according to the present invention from the opening, and then covering the opening with the lid;

an orienting process of applying a magnetic field to the alloy powder in a state where the alloy powder is filled in the space; and

a sintering process of sintering the alloy powder, which undergoes the orienting process, in a state where the alloy powder is filled in the space.

By using the method of manufacturing a sintered magnet according to the present invention, an RFeB sintered magnet containing a rare earth element R, Fe, and B as major components or an RCo sintered magnet containing the rare earth element R and Co as major components can be suitably manufactured, in which the rare earth element R is one element or two or more elements selected from Sc, Y, La, Ce, Pr, Nd, Pm, Sm, Eu, Gd, Tb, Dy, Ho, Er, Tm, Yb, and Lu. That is, in the method of manufacturing a sintered magnet according to the present invention, it is preferable that the alloy powder is a powder of an RFeB alloy containing a rare earth element R, Fe, and B as major components or a powder of an RCo alloy containing the rare earth element R and Co as major components.

The mold for manufacturing a sintered magnet which contains a lid having a concave portion on an inner surface can make mechanical grinding and mechanical polishing for chamfering a sintered magnet unnecessary since an obtuse angle is formed at the portion where the concave inner wall surface and the concave top surface intersect with each other as described above. In addition, a sintered magnet having a complex shape can be manufactured since the shape of the concave portion can be freely designed. In order to exhibit the above effects, it is not necessary that the concave inner wall surface and the concave top surface intersect with each other at an obtuse angle. Such a mold for manufacturing a sintered magnet is a mold for manufacturing a sintered magnet by filling the mold with an alloy powder of raw materials of a sintered magnet and then orienting and sintering the alloy powder in a state of being put into the mold without compression-molding the alloy powder, the mold including:

a) a main body having an opening; and

b) a lid that covers the opening and has an inner surface having a concave portion which is located on the main body side in a state of covering the opening.

By using a mold for manufacturing a sintered magnet and a method of manufacturing a sintered magnet according to the present invention, a sintered magnet can be manufactured without performing mechanical grinding and mechanical polishing for chamfering.

### BRIEF DESCRIPTION OF THE DRAWINGS

FIG. 1 is vertical cross-sectional views illustrating a configuration of a mold for manufacturing a sintered magnet according to an embodiment of the present invention; (a) of FIG. 1 is a vertical cross-sectional view illustrating a state where a lid of the mold is not fitted to an opening of a main body; and (b) of FIG. 1 is a vertical cross-sectional view illustrating a state where the lid is fitted to the opening.

FIG. 2 is vertical cross-sectional views illustrating a configuration of a mold for manufacturing a sintered magnet according to another embodiment of the present invention; (a) of FIG. 2 is a vertical cross-sectional view illustrating a state where a lid of the mold is not fitted to an opening of a main body; and (b) of FIG. 2 is a vertical cross-sectional view illustrating a state where the lid is fitted to the opening.

FIG. 3 is a schematic diagram illustrating a method of manufacturing a sintered magnet by using the mold for manufacturing a sintered magnet according to the present embodiment, including: supplying an alloy powder to the inside of a space of a main body of the mold ((a) of FIG. 3); fitting a lid to an opening of the main body ((b) of FIG. 3); orienting the alloy powder inside the mold in a magnetic field ((c) of FIG. 3); and sintering the alloy powder inside the mold ((d) of FIG. 3), to obtain a sintered body in which the alloy powder is sintered and shrunk ((e) of FIG. 3).

FIG. 4 is vertical cross-sectional views illustrating configurations of molds for manufacturing a sintered magnet according to other embodiments of the present invention in a state where a lid of the mold is fitted to an opening of a main body; (a) of FIG. 4 illustrates an embodiment where an inner surface of the lid intersects with an inner wall surface of the main body at an obtuse angle of greater than 135°; and (b) of FIG. 4 illustrates another embodiment where an inner surface of the lid intersects with an inner wall surface of the main body at an obtuse angle of less than 135°.

FIG. 5 is views illustrating a configuration of a mold for manufacturing a sintered magnet according to another embodiment of the present invention in a state where a lid of the mold is fitted to an opening of a main body; (a) of FIG. 5 is a vertical cross-sectional view; and (b) of FIG. 5 is a vertical cross-sectional view taken along line A-A′ of (a).

FIG. 6 is vertical cross-sectional views illustrating configurations of molds for manufacturing a sintered magnet according to other embodiments of the present invention in a state where a lid of the mold is fitted to an opening of a main body; (a) of FIG. 6 illustrates an embodiment where a cross-section of a cavity has a vertically inverted dome shape; (b) of FIG. 6 illustrates an embodiment where a cross-section of a cavity has a step shape; (c) of FIG. 6 illustrates an embodiment where a cross-section of a cavity has a shape whose width decreases toward an inner bottom surface; and (d) of FIG. 6 illustrates an embodiment where a cross-section of a cavity has a shape with a protrusion.

FIG. 7 is vertical cross-sectional views illustrating examples of a mold for manufacturing a sintered magnet of the present invention, which includes a lid having a concave portion on an inner surface, in a state where the lid of the mold covers an opening of a main body; (a) of FIG. 7 illustrates an embodiment where a concave inner surface intersects with an inner wall surface of the main body on a plane surface; and (b) of FIG. 7 illustrates an embodiment where a concave inner surface intersects with an inner wall surface of the main body on a curved surface.

FIG. 8 is vertical cross-sectional views illustrating other examples of a mold for manufacturing a sintered magnet of the present invention, which includes a lid having a concave portion on an inner surface, in a state where the lid of the mold covers an opening of a main body; (a) of FIG. 8 illustrates an embodiment where a concave top surface intersects with a concave inner wall surface on a plane surface; and (b) of FIG. 8 illustrates an embodiment where a concave top surface intersects with a concave inner wall surface on a curved surface.

FIG. 9 is vertical cross-sectional views illustrating examples of an integrated type mold for manufacturing a sintered magnet which includes plural cavities, according to the present invention; (a) of FIG. 9 illustrates an example in which a lid is fitted to an opening of a main body; and (b) of FIG. 9 illustrates an example in which a lid is not fitted to an opening of a main body, and an inner surface has a concave portion.

FIG. 10 is views illustrating a configuration of a mold for manufacturing a sintered magnet according to an embodiment of the present invention in which plural main bodies having the same shape are used by overlapping with each other; (a) of FIG. 10 is a vertical cross-sectional view of the mold; and (b) of FIG. 10 is a vertical cross-sectional view illustrating a state where plural molds are used by overlapping with each other.

FIG. 11 is views illustrating a mold for manufacturing a sintered magnet according to an embodiment of the present invention, in which plural main bodies having the same shape are used by overlapping with each other, and plural cavities are formed in each main body; (a) of FIG. 11 illustrates a top view of the mold; (b) of FIG. 11 illustrates a front view of the mold; and (c) of FIG. 11 illustrates a side view of the mold.

FIG. 12 is side views illustrating a state where plural molds for manufacturing a sintered magnet of FIG. 11 are used by overlapping with each other; (a) of FIG. 12 is a side view of the state where plural molds are used by overlapping with each other; and (b) of FIG. 12 is a side view illustrating a tray which holds the lowermost mold.

FIG. 13 is a vertical cross-sectional view illustrating an example of a mold for manufacturing a sintered magnet, which includes a lid having a concave portion on an inner surface, in a state where the lid of the mold covers an opening of a main body, in which the concave portion does not have surfaces intersecting with concave inner wall surfaces at an obtuse angle.

FIG. 14 is a vertical cross-sectional view illustrating an example of a conventional mold for manufacturing a sintered magnet.

### DETAILED DESCRIPTION OF THE INVENTION

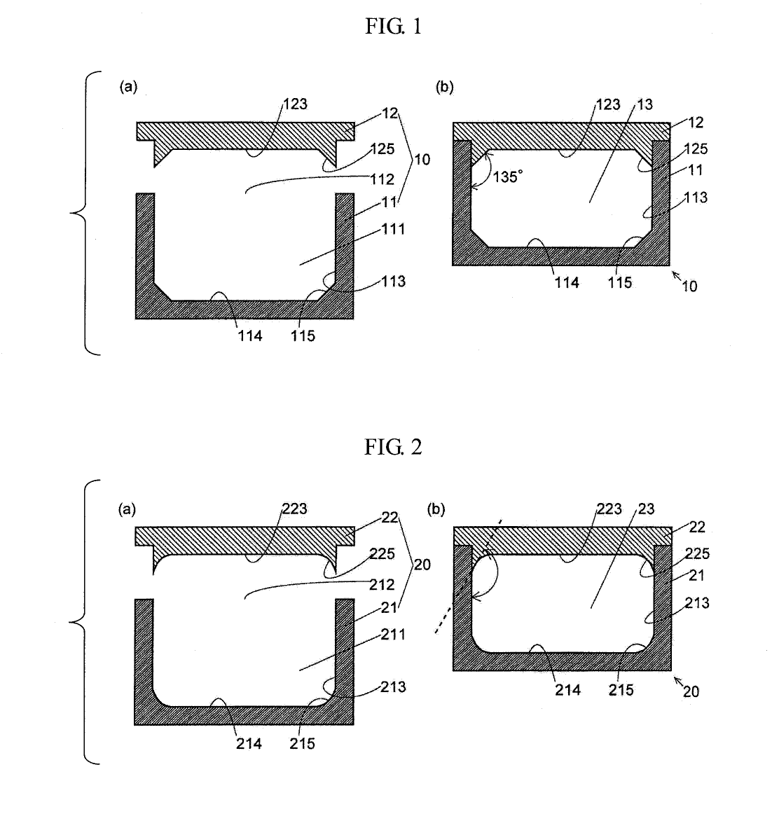

Embodiments of a mold for manufacturing a sintered magnet (hereinafter, simply abbreviated as “mold”) according to the present invention and a method of manufacturing a sintered magnet by using the mold will be described with reference to FIGS. 1 to 13.

### Embodiments

FIG. 1 is vertical cross-sectional views illustrating a configuration of a mold 10 according to an embodiment of the present invention for manufacturing a cuboid sintered magnet. The mold 10 includes a main body 11 and a lid 12.

The main body 11 has a space 111 into which an alloy powder is put, and has an opening 112 of the space 111, formed above the main body 11. In this embodiment, the shape of the space 111 is basically cuboid, inner wall surfaces 113 correspond to four rectangular surfaces of the cuboid, and an inner bottom surface 114 corresponds to one rectangular surface of the cuboid. However, the inner bottom surface 114 has a shape of being bent so as to intersect with the inner wall surfaces 113 at an obtuse angle in the vicinity of a rectangular side intersecting with the inner wall surfaces 113. In the present embodiment, this obtuse angle is 135°. These bent portions 115 correspond to so-called C surfaces, which are obtained by chamfering edge lines where the inner wall surfaces 113 and the inner bottom surface 114 intersect with each other at a right angle, into plane surfaces. In addition, bent portions corresponding to C surfaces are also formed at edge lines where the inner wall surfaces 113 intersect with each other (not illustrated). These portions will be referred to as main body-side C surfaces. The main body 11 is formed of dense carbon such as carbonaceous extruded material, graphite extruded material, graphite pressed material, isotropic graphite material, and carbon fiber reinforced carbon composite material.

The lid 12 has a shape corresponding to the opening 112 of the main body 11 so as to be fitted to the opening 112. An inner surface 123 of the lid 12, that is, a surface on the side of the space 111 of the main body 11 in a state of being fitted to the opening 112, basically has a rectangular shape parallel to the inner bottom surface 114 of the space 111 of the main body 11 in the fitted state. However, in the vicinity of each side of the rectangle, the inner surface 123 has a shape of being bent to the space 111 side and intersects with the inner wall surfaces 113 of the main body 11 at an obtuse angle. In the present embodiment, this obtuse angle is 135°. These bent portions 125 correspond to C surfaces, which are obtained by chamfering edge lines where the inner wall surfaces 113 of the main body 11 and the inner surface 123 of the lid 12 intersect with each other at a right angle. These bent portions 125 will be referred to as lid-side C surfaces. For example, when the length of one side of the inner surface 123 is 15 mm to 20 mm, the heights and the widths of the lid-side C surfaces 125 are 0.2 mm to 0.6 mm. As in the case of the main body 11, the lid 12 is formed of dense carbon.

As illustrated in (b) of FIG. 1, when the lid 12 is fitted to the opening 112 of the main body 11, a cuboid cavity 13 is formed which is surrounded by the inner wall surfaces 113 and the inner bottom surface 114 of the space 111 of the main body 11, and the inner surface 123 of the lid 12. As described above, since the main body-side C surfaces and the lid-side C surfaces are formed, the cuboid of the cavity 13 has a shape where all the edge lines are chamfered into C surfaces.

FIG. 2 illustrates a mold for manufacturing a cuboid sintered magnet according to another embodiment of the present invention. This mold 20 is the same as the mold 10, in that the mold 20 includes a main body 21 and a lid 22; the main body 21 has a space 211, and an opening 212 of the space 211, formed above the main body 21; and the lid 22 has a shape corresponding to the opening 212 of the main body 21 so as to be fitted to the opening 212. In the mold 20 according to this embodiment, the lid 22 has a curved surface in a portion of the inner surface 223 of the lid 22 in the vicinity of each side of the rectangle on the side of the space 211 of the main body 21 in the fitted state. In this curved surface 225, a tangent plane (indicated by a broken line in (b) of FIG. 2) of each point on intersection lines of the curved surface 225 with the inner wall surfaces 213 of the main body 21 intersects with the inner wall surfaces 213 at an obtuse angle. These curved surfaces 225 correspond to so-called R surfaces, which are obtained by chamfering edge lines where the inner wall surfaces 213 of the main body 21 and the inner surface 223 of the lid 22 intersect with each other at a right angle, into curved surfaces. These curved surfaces 225 will be referred to as lid-side R surfaces. The lid-side R surfaces 225 preferably has a curvature radius of 0.2 mm or greater. Main body-side R surfaces 215 are also formed at edge lines where the inner wall surfaces 213 of the main body 21 intersect with each other and where the inner wall surfaces 213 and an inner bottom surface 214 intersect with each other

As illustrated in (b) of FIG. 2, when the lid 22 is fitted to the opening 212 of the main body 21, a cuboid cavity 23 is formed which is surrounded by the inner wall surfaces 213 and the inner bottom surface 214 of the space 211 of the main body 21, and the inner surface 223 of the lid 22. The cuboid of the cavity 23 has a shape where all the edge lines are chamfered into the R surfaces.

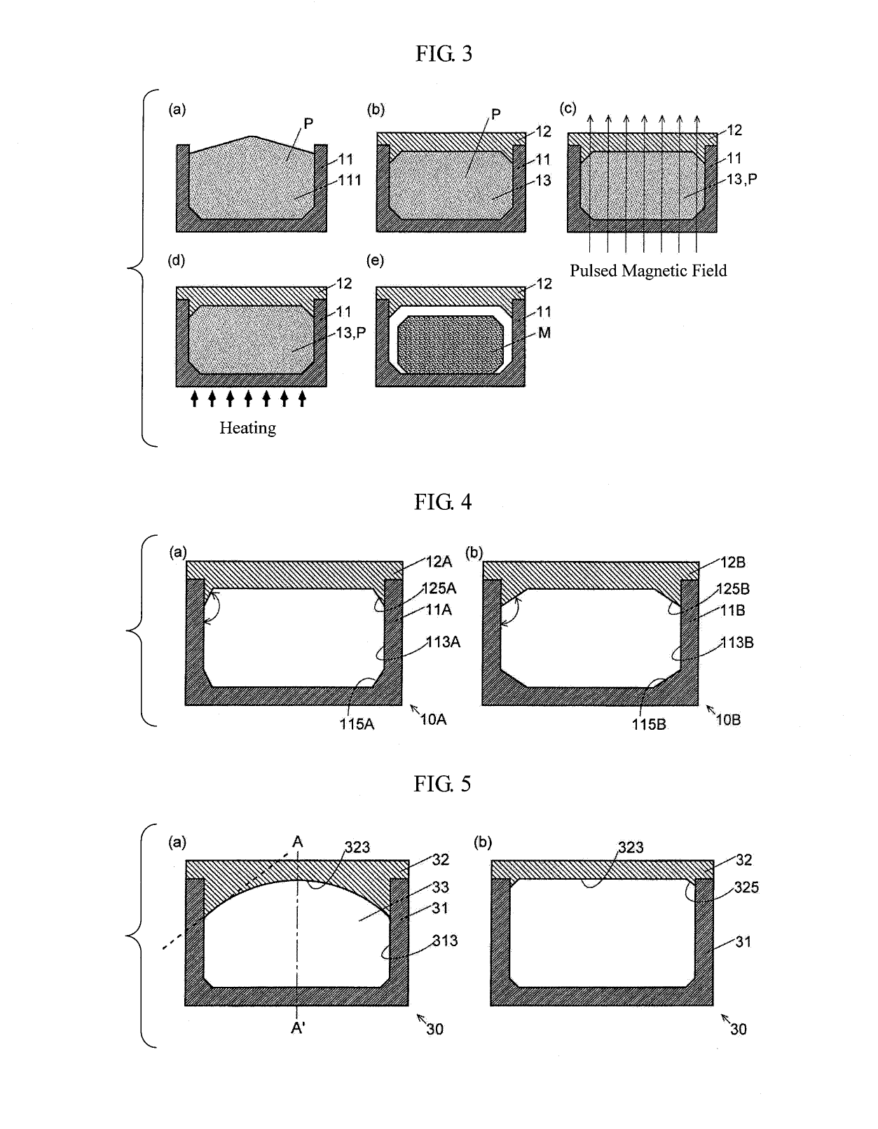

A method of manufacturing a sintered magnet by using the mold according to the embodiment through the PLP will be described with reference to FIG. 3. Here, a case of using the mold 10 will be described as an example, but the same shall be applied to cases of using the other mold according to the present invention. In addition, here, a case of manufacturing an RFeB (R₂Fe₁₄B) sintered magnet will be described as an example, but the same shall be applied to cases of manufacturing an RCo (RCo₅, R₂Co₇) sintered magnet and other sintered magnets.

First, an RFeB alloy ingot is pulverized to prepare an alloy powder P as raw materials. In order to obtain an RFeB sintered magnet having a high coercive force as described above, the alloy powder P preferably has an average particle size measured by using a dynamic light scattering method (laser method) of 5 μm or less. The obtained alloy powder P is supplied to the inside of the space 111 of the main body 11 ((a) of FIG. 3). Next, the lid 12 is attached to the opening 112 of the main body 11 ((b) of FIG. 3). At this time, due to the inner surface 123 of the lid 12, the alloy powder P is put into the space 111, and a pressure is applied to the alloy powder P. This pressure can be adjusted by controlling the amount of the alloy powder P supplied to the inside of the space 111, and is preferably 2 MPa or lower which is sufficiently lower than a pressure (typically, several tens of MPa) applied during compression molding. In this way, the cavity 13 inside the mold 10 is filled with the alloy powder P. As described above, the cavity 13 has a shape where all the edge lines of the cuboid are chamfered into the C surfaces.

Subsequently, in a state where the cavity 13 is filled with the alloy powder P, a pulsed magnetic field is applied to the alloy powder P in a thickness direction of the mold 10 ((c) of FIG. 3). As a result, the particles of the alloy powder P are oriented such that the c-axis of fine crystals inside the particles of the alloy powder P faces a direction parallel to the magnetic field. Next, in a state where the cavity 13 is filled with the alloy powder P with the oriented particles, the alloy powder P is heated at a temperature of about 900° C. to 1,100° C. As a result, the alloy powder P is sintered ((d) of FIG. 3). At this time, the alloy powder P is sintered so as to be shrunk while maintaining the shape of the cavity 13 (referred to as sintering shrinkage). As a result, a sintered magnet M having a similar shape to that of the cavity 13 is obtained ((e) of FIG. 3). Accordingly, the obtained sintered magnet M has a shape in which the edge lines of the cuboid are chamfered into the C surfaces corresponding to the shape of the main body-side C surfaces 115 and the lid-side C surfaces 125 of the cavity 13.

The mold according to the present invention may have a shape other than the above-described examples. For example, in a mold 1 OA illustrated in (a) of FIG. 4, main body-side C surfaces 115A and lid-side C surfaces 125A intersect with inner wall surfaces 113A of a main body 11A at an obtuse angle of greater than 135°. In a mold 10B illustrated in (b) of FIG. 4, main body-side C surfaces 115B and lid-side C surfaces 125B intersect with inner wall surfaces 113B of a main body 11B at an obtuse angle of less than 135°.

In a mold 30 illustrated in FIG. 5, an inner surface 323 of a lid 32 has a dome shape in a specific vertical cross-section as illustrated in (a) of FIG. 5, and a vertical cross-section vertically shifted from the above vertical cross-section has the same dome shape. A main body 31 has a similar shape to that of the main body 11 of the above-described mold 10. A tangent plane (indicated by a broken line in (a) of FIG. 5) of the dome-shaped inner surface 323 intersects with the inner wall surfaces 313 of the main body 31 at an obtuse angle at each point of intersection lines. In addition, in a cross-section (taken along line A-A′ of (a) of FIG. 5) perpendicular to these cross-sections, the inner surface 323 is flat, and has C surfaces 325 formed at both ends ((b) of FIG. 5). This mold 30 has a cavity 33 in which a vertical cross-section in one axial direction has the same dome shape, and thus, a sintered magnet corresponding to the shape is manufactured.

The space of the main body may also have various shapes. In a mold 40 illustrated in (a) of FIG. 6, an inner bottom surface 414 of a main body 41 has a similar dome shape to that of the inner surface 323 of the lid 32 in the above-described mold 30, and a tangent plane of the inner bottom surface 414 intersects with inner wall surfaces 413 at an obtuse angle at each point of intersection lines. A lid 42 is similar to the lid 12 of the above-described mold 10. A cavity 43 of the mold 40 has a shape like that the cavity 33 of the mold 30 is vertically inverted, and thus a sintered magnet having a similar dome shape to that of the mold 30 is manufactured. In a mold 40A illustrated in (b) of FIG. 6, a vertical cross-section of a main body 41A has a bilaterally symmetric step shape. Corners corresponding to end portions of tread surfaces of the steps are chamfered into C surfaces 416A. A lid 42A has a similar shape to that of the lid 42 of the mold 40. In a mold 40B illustrated in (c) of FIG. 6, a vertical cross-section of a cavity 43B has a shape whose width gradually decreases from an opening side toward an inner bottom surface 414B side of a main body 41B, and inner wall surfaces 413B are inclined. A lid 42B has a similar shape to that of the lid 42 of the mold 40. An angle formed between the inner wall surfaces 413B of the main body 41B and lid-side C surfaces 425B of the lid 42B is less than those of other examples but is an obtuse angle.

In a mold 40C illustrated in (d) of FIG. 6, a protrusion 46 is provided so as to surround inner wall surfaces 413C in a plane parallel to an inner bottom surface 414C. The shapes of other components are similar to those of the above-described mold 10. Due to sintering shrinkage caused during sintering, a sintered magnet which has a substantially similar shape to but more shrunk than that of a cavity 43C is obtained in the PLP. Therefore, when the protrusion 46 is not significantly large, a sintered magnet can be extracted from the mold 40C without being caught by the protrusion 46.

A sintered magnet obtained from the mold 40C has a shape in which a groove corresponding to the protrusion 46 is formed on side surfaces of a cuboid.

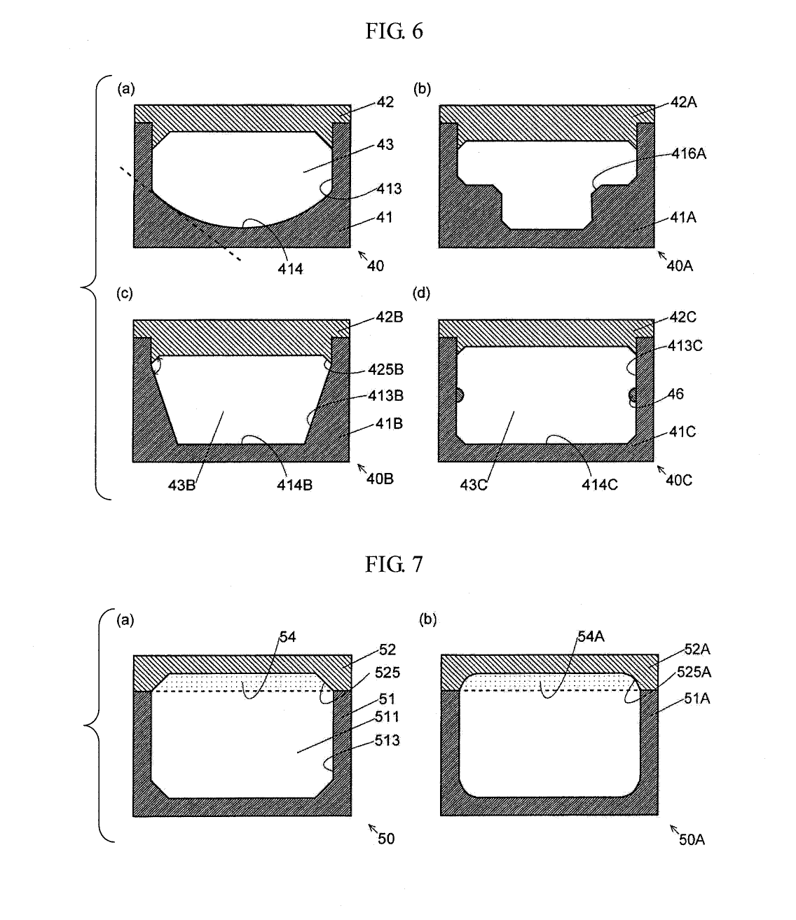

FIG. 7 illustrates examples of the mold according to the first aspect, which have the concave portion on the inner surface of the lid. A mold 50 illustrated in (a) of FIG. 7 includes a main body 51 having a similar shape to that of the main body 11 of the above-described mold 10, and a lid 52 having a concave portion 54 on an inner surface. A horizontal cross-section of the concave portion 54 has a rectangular shape corresponding to an opening of a main body 51. Portions of the inner surface of the lid 52 other than the concave portion 54 are flat. By placing the portions on edges around the opening of the main body 51, the opening of the main body 51 is covered with the lid 52. In the vicinity of each side of the rectangle, the inner surface of the concave portion 54 has a shape of being bent to a space 511 side of the main body 51 and intersects with inner wall surfaces 513 of the main body 51 at an obtuse angle. These bent portions 525 will be referred to as lid-side C surfaces.

In the mold 50 according to this embodiment, the alloy powder is supplied to the internal space 511 of the main body 51, and then the opening of the main body 51 is covered with the lid 52. At this time, by supplying the alloy powder in a volume more than that of the space 511, a substantially entire space (cavity) remaining after the opening is covered with the lid 52 can be filled. Due to the reason described below, the cavity does not need to be completely filled with the alloy powder. In a state where the lid 52 is pressed against the mold 50 through a piston or the like, the alloy powder is oriented by applying a magnetic field to the alloy powder inside the mold 50. Here, even when a space not occupied by the alloy powder is present above the cavity before the application of a magnetic field, the powder moves by vertically applying a magnetic field. As a result, the entire cavity is filled with the alloy powder. Thereafter, similar to the above-described embodiment, the alloy powder is sintered in a state where the cavity is filled with the alloy powder.

A mold 50A illustrated in (b) of FIG. 7 has a similar configurations to those of the mold 50 illustrated in (a) of FIG. 7, except that a concave portion 54A of a lid 52A has lid-side R surfaces 525A instead of the lid-side C surfaces 525, and that a main body 51A has a similar shape to that of the main body 21 of the above-described mold 20.

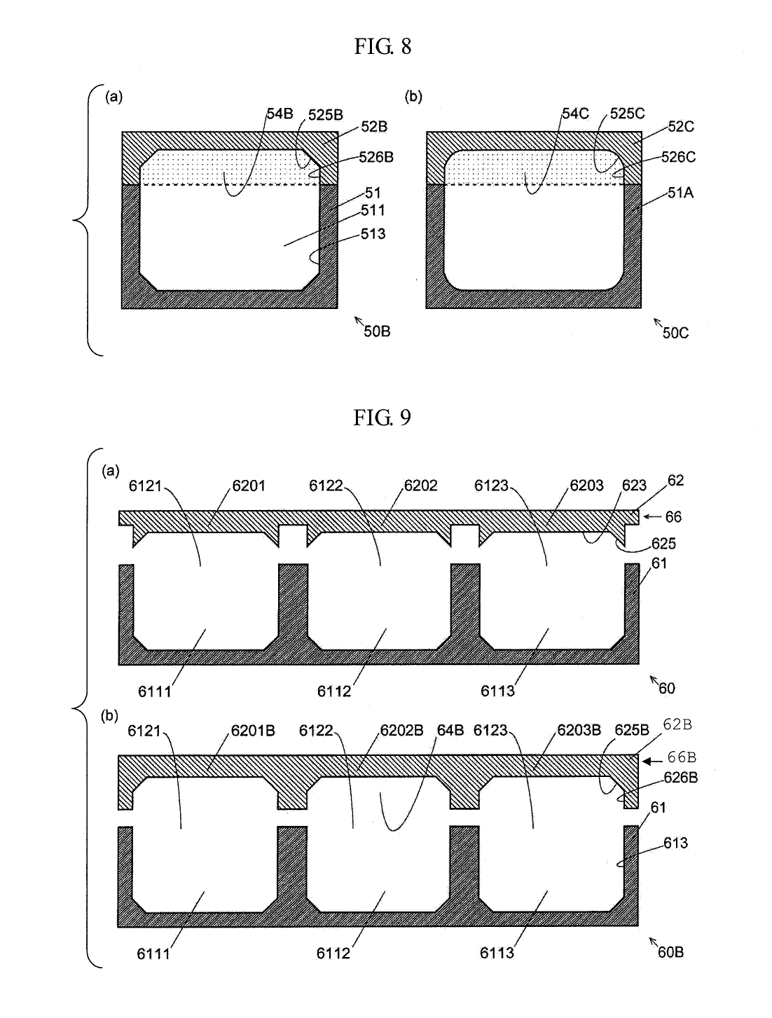

FIG. 8 illustrates examples of the mold according to the second aspect. A mold 50B illustrated in (a) of FIG. 8 includes a main body 51 similar to the mold 50 illustrated in (a) of FIG. 7, and a lid 52B having a concave portion 54B on an inner surface. Portions of the inner surface of the lid 52B other than the concave portion 54B are flat, and the lid 52B covers the opening of the main body 51 similar to the lid 52 of the mold 50. The concave portion 54B includes concave inner wall surfaces 526B that are connected to inner wall surfaces 513 of the main body 51, and a concave top surface 525B that has plane surfaces (C surfaces) which intersect with the concave inner wall surface 526B at obtuse angle in the intersection lines.

A method of using the mold 50B according to this embodiment is similar to that of the above-described mold 50. That is, the alloy powder is supplied to the internal space 511 of the main body 51, and then the opening of the main body 51 is covered with the lid 52B. The alloy powder may be supplied in a volume more than that of the space 511 so as to fill a substantially entire cavity remaining after the opening is covered with the lid 52B, and the cavity does not need to be completely filled with the alloy powder. Next, in a state where the lid 52B is pressed against the mold 50 through a piston or the like, the alloy powder is oriented by applying a magnetic field to the alloy powder inside the mold 50. Thereafter, the alloy powder is sintered in a state where the cavity is filled with the alloy powder. As a result, a sintered magnet having a shape which is chamfered into C surfaces corresponding to the C surfaces of the concave top surface 525B is obtained.

A mold 50C illustrated in (b) of FIG. 8 is different from the mold 50B, in that, instead of the concave top surface 525B, a concave portion 54C of a lid 52C includes a concave top surface 525C which has curved surfaces (R surfaces) where a tangent plane of each point on intersection lines with the concave inner wall surfaces 526C intersects with the concave inner wall surfaces 526C at an obtuse angle. In addition, the mold 50C is different from the mold 50B, also in that a main body 51A has a similar shape to that of the main body 51A in the above-described mold 50A. The mold 50C has similar configurations to those of the mold 50B except for these two points.

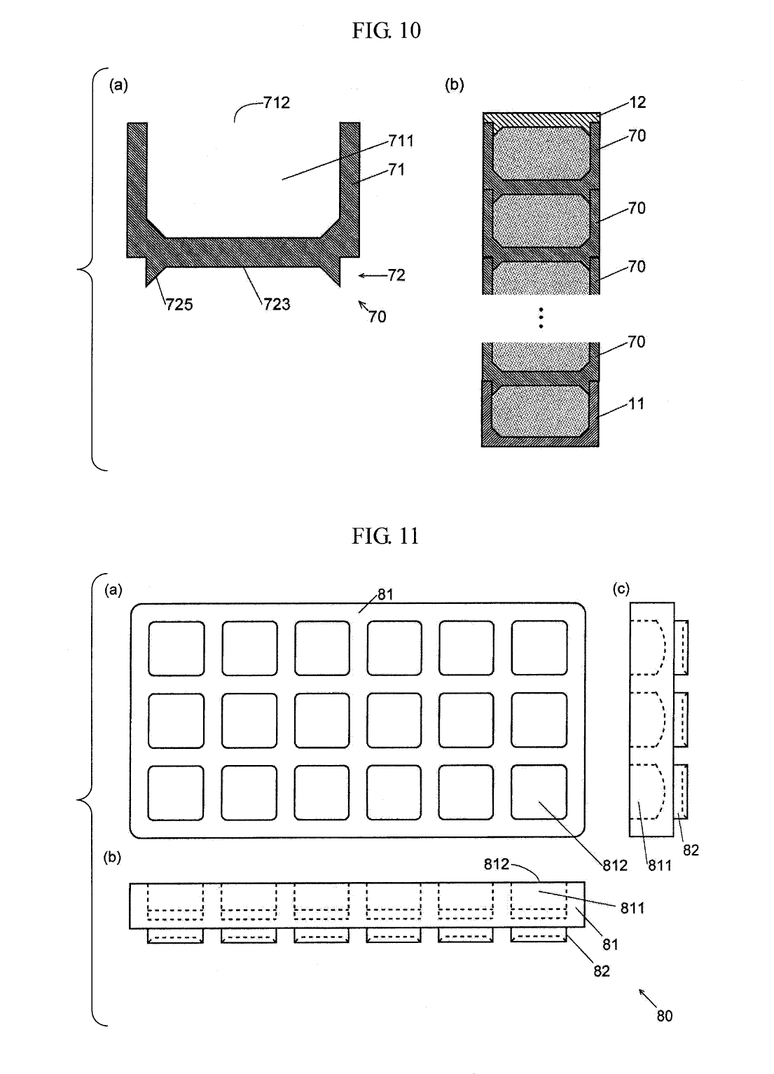

FIG. 9 illustrates examples of the integrated type mold having plural cavities. A mold 60 illustrated in (a) of FIG. 9 is an example of the mold according to the first aspect of the present invention and includes a main body 61 and a lid unit 62. In the main body 61, three spaces 6111, 6112, and 6113 and openings 6121, 6122 and 6123 corresponding to the respective spaces are arranged in a row. In addition, in the lid unit 62, lids 6201, 6202, and 6203 corresponding to the respective openings of the main body 61 are formed in a row on a single base plate 66. Each of the spaces 6111, 6112, and 6113 has a similar shape to that of the space 111 of the above-described mold 10. In addition, each of the lids 6201, 6202, and 6203 includes inner surface 623 which includes lid-side C surfaces 625 similar to the lid 12 of the above-described mold 10. The numbers of the spaces and the openings of the main body and the number of the lids are not limited to the above-described numbers. In addition, the spaces and the openings of the main body and the lids may be two-dimensionally arranged (refer to FIG. 11 below).

According to this mold 60, a troublesome operation of covering each of the openings 6121 to 6123 with each of the lids is not necessary, and the openings can be accurately covered with the lids at a stroke. Therefore, the manufacturing efficiency can be improved.

A mold 60B illustrated in (b) of FIG. 9 is an example of the mold according to the second aspect of the present invention and includes the main body 61 that has a similar configuration to that of the mold 60, and a lid unit 62B that is different from that of the mold 60. In the lid unit 62B, lids 6201B, 6202B, and 6203B corresponding to the respective openings of the main body 61 are formed. In each of the lids 6201B, 6202B, and 6203B, a concave portion 64B having a similar configuration to that of the concave portion 54B of the lid 52B of the above-described mold 50B is provided. That is, each of the concave portions 64B includes concave inner wall surfaces 626B that are connected to inner wall surfaces 613 of each space of the main body 61, and a concave top surface 625B that has plane surfaces which intersect with the concave inner wall surface 626B at obtuse angle in the intersection lines. In the second aspect, the numbers of the spaces and the openings of the main body and the number of the lids are also not limited to the above-described numbers. In addition, the spaces and the openings of the main body and the lids may be two-dimensionally arranged.

FIG. 10 illustrates an example of a mold where plural main bodies having the same shape are used by overlapping with each other. In this mold 70, a convex portion 72 corresponding to a lid is formed on a bottom surface of a main body 71. The shape of the main body 71 is similar to that of the main body 11 of the above-described mold 10 and includes a space 711 and an opening 712. Similar to the lid 12 of the above-described mold 10, the convex portion 72 has a shape corresponding to the opening 712, and lid-side C surfaces 725 are provided in the vicinity of the respective sides of a rectangular inner surface 723.

As illustrated in (b) of FIG. 10, the plural molds 70 are used by overlapping with each other in such a manner that the convex portion 72 of one mold 70 is fitted to the opening 712 of another mold 70. Accordingly, since it is not necessary to cover the respective molds 70 with separate lids, the number of steps at the same height can be increased, and thus the manufacturing efficiency of a sintered magnet can be improved. The lid 12 of the above-described mold 10 can be attached to the opening 712 of the uppermost mold 70. In addition, on the lowermost side, the main body 11 of the above-described mold 10 may also be used instead of the mold 70.

FIG. 11 illustrates an example of a mold in which plural main bodies having the same shape are used by overlapping with each other, and plural cavities are formed in each main body. In this mold 80, spaces 811 and openings 812 are two-dimensionally arranged on a plate-shaped main body 81 in a pattern of 3 (vertical)×6 (horizontal). In addition, in the bottom of the main body 81, convex portions 82 corresponding to the openings are two-dimensionally arranged at positions below the respective openings 812 in a pattern of 3 (vertical)×6 (horizontal). In this embodiment, the space 811 has a similar shape to that of the above-described mold 40. In addition, each convex portion 82 has a similar shape to that of the convex portion 72 of the mold 70.

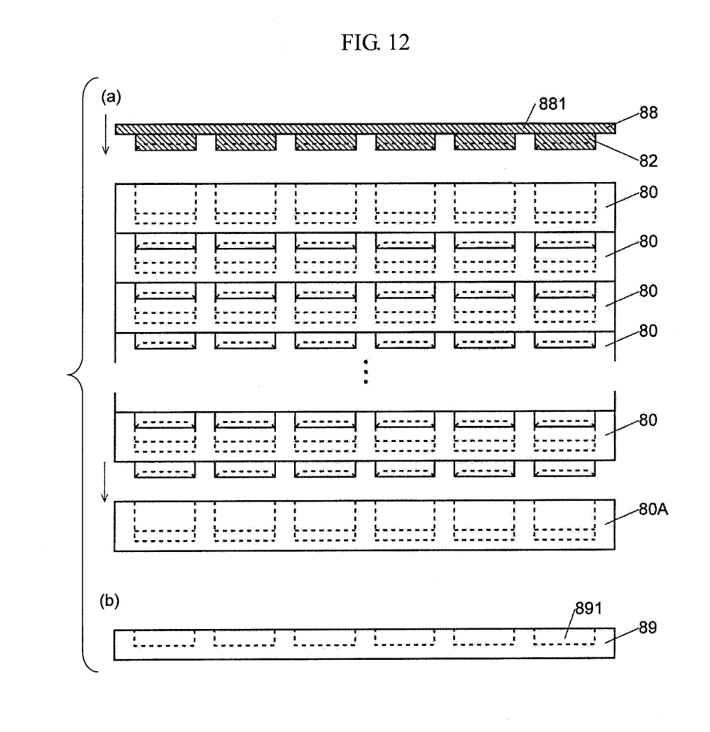

As illustrated in (a) of FIG. 12, the plural molds 80 are used by overlapping with each other in such a manner that the convex portion 82 of one mold 80 is fitted to the opening 812 of another mold 80 in a one-to-one manner. Accordingly, it is not necessary to cover each of the openings with each of the lids, and the openings can be accurately covered with the lids at a stroke. In addition, since it is not necessary to provide separate lids, the manufacturing efficiency can be improved.

A lid 88 in which the convex portions 82 are provided below a plate 881 may be attached to the uppermost mold 80. In addition, in the lowermost mold 80A, the convex portions 82 are not necessarily provided. Alternatively, a mold 80 (having the convex portions 82) may be used as the lowermost mold, and the bottom of the mold 80 may be held by a tray 89 which includes concave portions 891 corresponding to the convex portions 82 on a plate ((b) of FIG. 12).

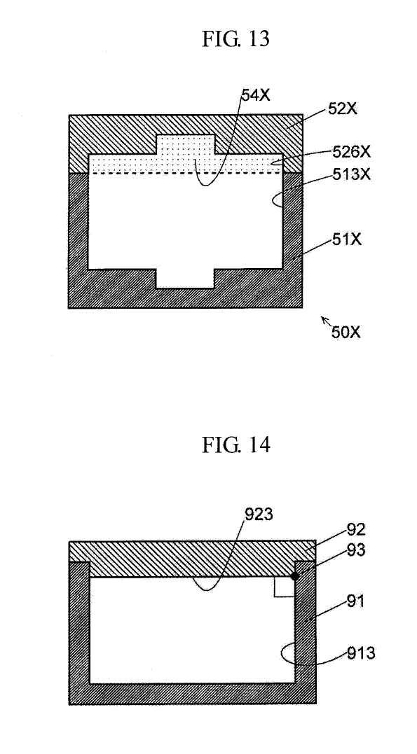

FIG. 13 illustrates a mold according to an embodiment which includes a lid having a concave portion free of R surfaces and C surfaces on an inner surface. This mold 50X includes a main body 51X that has a space where a protrusion is formed on a lower surface of a cuboid, and a lid 52X that has a concave portion 54X on an inner surface, in which the concave portion 54X is a space where a protrusion is formed on an upper surface of the cuboid. The concave portion 54X has concave inner wall surfaces 526X which are connected to inner wall surfaces 513X of the main body 51X, but these surfaces do not have R surfaces and C surfaces. By providing such a concave portion 54X in the lid 52X, a sintered magnet in which convex portions are formed on two opposite surfaces of the cuboid can be obtained. By using the lids 52X having the concave portion 54X, a sintered magnet having a complex shape can be manufactured.

While the present invention has been described in detail and with reference to specific embodiments thereof, it will be apparent to one skilled in the art that various changes and modifications can be made therein without departing from the spirit and scope of the present invention.

The present application is based on Japanese Patent Application No. 2014-110352 filed on May 28, 2014, and the contents thereof are incorporated herein by reference.

### DESCRIPTION OF REFERENCE NUMERALS AND SIGNS

10, 10A, 10B, 20, 30, 40, 40A, 40B, 40C, 50, 50A, 50B, 50C, 50X, 60, 60B, 70, 80, 80A: MOLD
11, 11A, 11B, 21, 31, 41, 41A, 41B, 41C, 51, 51A, 51X, 61, 71, 81, 91: MAIN BODY
111, 211, 511, 6111 to 6113, 711, 811: INTERNAL SPACE OF MAIN BODY
112, 212, 6121 to 6123, 712, 812: OPENING
113, 113A, 113B, 213, 313, 413, 413B, 413C, 513, 513X, 613, 913: INNER WALL SURFACE OF MAIN BODY
114, 214, 414, 414B, 414C: INNER BOTTOM SURFACE OF MAIN BODY
115, 115A, 115B: MAIN BODY-SIDE C SURFACE
12, 12A, 12B, 22, 32, 42, 42A, 42B, 42C, 52, 52A, 52B, 52C, 52X, 6201 to 6203, 6201B to 6203B, 88, 92: LID
62: LID UNIT
123, 223, 323, 623, 723, 923: INNER SURFACE OF LID
125, 125A, 125B, 325, 425B, 525, 625, 725: LID-SIDE C SURFACE
13, 23, 33, 43, 43B, 43C: CAVITY
215: MAIN BODY-SIDE R SURFACE
225, 525A: CURVED SURFACE (LID-SIDE R SURFACE)
416A: C SURFACE
46: PROTRUSION
525B, 525C, 625B: CONCAVE TOP SURFACE
526B, 526C, 526X, 626B: CONCAVE INNER WALL SURFACE
54, 54A, 54B, 54C, 54X, 64B: CONCAVE PORTION
66, 66B: BASE PLATE
72, 82: CONVEX PORTION
881: PLATE
89: TRAY
891: CONCAVE PORTION OF TRAY
93: EDGE LINE
M: SINTERED MAGNET
P: ALLOY POWDER

What is claimed is:

1. A mold for manufacturing a sintered magnet by filling the mold with an alloy powder of raw materials of a sintered magnet and then orienting and sintering the alloy powder in a state of being put into the mold without compression-molding the alloy powder, the mold comprising:
a) a main body having an opening; and
b) a lid that covers the opening and has an inner surface which is located on a main body side in a state of covering the opening,
wherein the inner surface has a plane surface which intersects with an inner wall surface of the main body at an obtuse angle, or has a curved surface where a tangent plane of each point on an intersection line with the inner wall surface intersects with the inner wall surface at an obtuse angle.

2. The mold according to claim 1,
wherein the main body has a convex portion corresponding to the lid formed on a bottom surface of the main body.

3. The mold according to claim 1,
wherein the lid contains a concave portion on an inner surface and the concave portion has the plane surface which intersects with the inner wall surface of the main body at an obtuse angle, or has the curved surface where a tangent plane of each point on an intersection line with the inner wall surface intersects with the inner wall surface at an obtuse angle.

4. A mold for manufacturing a sintered magnet by filling the mold with an alloy powder of raw materials of a sintered magnet and then orienting and sintering the alloy powder in a state of being put into the mold without compression-molding the alloy powder, the mold comprising:
a) a main body having an opening; and
b) a lid that covers the opening and has an inner surface having a concave portion which is located on a main body side in a state of covering the opening,
wherein the inner surface has a concave inner wall surface and a concave top surface,
the concave inner wall surface is connected to an inner wall surface of the main body through one plane surface or curved surface, and
the concave top surface has a plane surface which intersects with the concave inner wall surface at an obtuse angle, or has a curved surface where a tangent plane of each point on an intersection line with the concave inner wall surface intersects with the concave inner wall surface at an obtuse angle.

5. The mold according to claim 1,
wherein the main body is an integrated main body having plurality of the openings in one-dimensionally or two-dimensionally, and
wherein the plurality of the lids corresponding to the plurality of the openings are formed on a plate.

6. The mold according to claim 4,
wherein the main body is an integrated main body having plurality of the openings in one-dimensionally or two-dimensionally, and
wherein the plurality of the lids corresponding to the plurality of the openings are formed on a plate.

7. A mold for manufacturing a sintered magnet by filling the mold with an alloy powder of raw materials of a sintered magnet and then orienting and sintering the alloy powder in a state of being put into the mold without compression-molding the alloy powder, the mold comprising:
a) a main body having an opening; and
b) a lid that covers the opening and has an inner surface having a concave portion which is located on a main body side in a state of covering the opening.

8. A method of manufacturing a sintered magnet comprising:
a filling process of supplying the alloy powder to an internal space of the main body of the molds for manufacturing a sintered magnet according to claim 1, from the opening, and then covering the opening with the lid;
an orienting process of applying a magnetic field to the alloy powder in a state where the alloy powder is filled in the space; and
a sintering process of sintering the alloy powder, which undergoes the orienting process, in a state where the alloy powder is filled in the space.

9. A method of manufacturing a sintered magnet comprising:
a filling process of supplying the alloy powder to an internal space of the main body of the molds for manufacturing a sintered magnet according to claim 4, from the opening, and then covering the opening with the lid;
an orienting process of applying a magnetic field to the alloy powder in a state where the alloy powder is filled in the space; and
a sintering process of sintering the alloy powder, which undergoes the orienting process, in a state where the alloy powder is filled in the space.

10. A method of manufacturing a sintered magnet comprising:
a filling process of supplying the alloy powder to an internal space of the main body of the molds for manufacturing a sintered magnet according to claim 6, from the opening, and then covering the opening with the lid;
an orienting process of applying a magnetic field to the alloy powder in a state where the alloy powder is filled in the space; and
a sintering process of sintering the alloy powder, which undergoes the orienting process, in a state where the alloy powder is filled in the space.

11. The method of manufacturing a sintered magnet according to claim 8,
wherein the alloy powder contains a powder of an RFeB alloy containing a rare earth element R, Fe, and B as major components or an RCo alloy containing the rare earth element R and Co as major components, and
the rare earth element R is at least one element selected from the group consisting of Sc, Y, La, Ce, Pr, Nd, Pm, Sm, Eu, Gd, Tb, Dy, Ho, Er, Tm, Yb, and Lu.

12. The method of manufacturing a sintered magnet according to claim 9,
wherein the alloy powder contains a powder of an RFeB alloy containing a rare earth element R, Fe, and B as major components or an RCo alloy containing the rare earth element R and Co as major components, and
the rare earth element R is at least one element selected from the group consisting of Sc, Y, La, Ce, Pr, Nd, Pm, Sm, Eu, Gd, Tb, Dy, Ho, Er, Tm, Yb, and Lu.

13. The method of manufacturing a sintered magnet according to claim 10,
wherein the alloy powder contains a powder of an RFeB alloy containing a rare earth element R, Fe, and B as major components or an RCo alloy containing the rare earth element R and Co as major components, and
the rare earth element R is at least one element selected from the group consisting of Sc, Y, La, Ce, Pr, Nd, Pm, Sm, Eu, Gd, Tb, Dy, Ho, Er, Tm, Yb, and Lu.
